(19) United States
(12) Patent Application Publication
(10) Pub. No.: US 2020/0057519 A1
(43) Pub. Date: Feb. 20, 2020

(54) ARRAY SUBSTRATE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Yu ZHAO, Wuhan, Hubei (CN)

(21) Appl. No.: 16/099,215

(22) PCT Filed: Aug. 31, 2018
(86) PCT No.: PCT/CN2018/103574

§ 371 Date: Nov. 6, 2018

(30) Foreign Application Priority Data
Aug. 15, 2018 (CN) 201810927863.1

(51) Int. Cl. G06F 3/047; G06F 3/041; G02F 1/1333; G02F 1/1362

(52) U.S. Cl. CPC G06F 3/047; G06F 3/0412; G02F 2001/13629; G02F 1/136286; G06F 2203/04103; G02F 1/13338

(57) ABSTRACT

The present disclosure provides an array substrate including a base substrate and a touch control electrode layer formed on the base substrate. The touch control electrode layer includes a plurality of touch control electrode insulated from each other. The touch control electrodes are electrically connected to a driving circuit by a plurality of touch control lines. The touch control lines formed in two adjacent touch control electrodes are electrically connected to each other by at least one bridge. The touch control lines and the touch control electrodes are formed in a same layer. The bridge and the touch control electrodes are formed in different layers.

### CROSS REFERENCE TO RELATED APPLICATION

This application claims the priority of International Application No. PCT/CN2018/103574 filed on 2018 Aug. 31, which claims priority to Chinese Application No. 201810927863.1, filed on 2018 Aug. 15. The entire disclosures of each of the above applications are incorporated herein by reference.

### BACKGROUND OF THE INVENTION

### Field of Invention

The present application relates to displays, and particularly to an array substrate.

### Description of Prior Art

With demand for thin and light liquid crystal panels, embedded touch control technology has become one of the necessary choices of panels. An embedded touch control display panel differs from a non-embedded touch control display panel in that the embedded touch control display panel has an additional an additional film layer structure: a touch control line layer and an insulating layer.

Structure of an embedded touch control display panel is shown in FIG. 1, where in a planar mechanism of a display area of the embedded touch control display panel, the touch electrodes are electrically connected to the touch control lines by insulating via holes. However, during design of the touch control lines, part of the touch control lines is electrically connected to the touch control lines by the insulating via holes, and in order to simplify the embedded touch control display panel, the touch control lines are usually set as a non-penetrating structure.

In generally, designs of the embedded touch control display panel functionally meet the touch control requirements of users, however, because the touch control lines and the insulating layers are increased to increase costs of the array substrate and to make processes of manufacturing the array substrate complicated. Therefore, an array substrate is an urgently needed to solve the above problems.

### SUMMARY OF THE INVENTION

The application mainly provides an array substrate to solve a problem of touch control lines and insulating layers increasing costs of the array substrate and making processes of manufacturing the array substrate complicated.

According to one aspect of one embodiment of the present disclosure, an array substrate is provided and includes: a base substrate and a touch control electrode layer and an insulating layer formed on the base substrate;

the touch control electrode layer includes a plurality of touch control electrode insulated from each other, the touch control electrodes are electrically connected to a driving circuit by a plurality of touch control lines, the touch control lines formed in two adjacent touch control electrodes are electrically connected to each other by at least one bridge;

the insulating layer includes a plurality of lead via holes, the lead via holes are electrically connected to the touch control electrodes corresponding to the lead via holes; and

wherein the touch control lines and the touch control electrodes are formed in a same layer, the bridge and the touch control electrodes are formed in different layers.

According to one aspect of one embodiment of the present disclosure, a plurality of interspaces are defined in the touch control electrodes, the touch control lines are formed in the interspaces of the touch control electrodes;

the touch control lines of each of the touch control electrodes include a first line electrically connected to the touch control electrode, the touch control lines of each of the touch control electrodes formed near the driving circuit further include a second line insulating with the touch control electrode, the second lines are connected to the first lines corresponding to the second lines by the bridges.

According to one aspect of one embodiment of the present disclosure, the touch control electrodes includes a plurality of touch control ends, the first lines of the touch control lines are electrically connected to the touch control electrodes by the touch control ends.

According to one aspect of one embodiment of the present disclosure, each of the touch control electrodes is electrically connected to the touch control lines by n touch control ends, the n is an integer and is greater than or equal to 1, each of the touch control electrodes is electrically connected to the driving circuit by n touch control lines;

wherein one touch control line is defined from one touch control end to the driving circuit.

According to one aspect of one embodiment of the present disclosure, the insulating layer is formed between the base substrate and the touch control electrode layer, the base substrate includes a plurality of pixel units, the pixel units include a plurality of thin film transistors, the bridges and gate electrodes are formed in a same layer.

According to one aspect of one embodiment of the present disclosure, the array substrate further includes a plurality of pixel electrode lines electrically connected to the touch control lines, the insulating layer is formed between the pixel electrode lines and the touch control electrode layer, the bridges are made from the pixel electrode lines.

According to one aspect of one embodiment of the present disclosure, the pixel electrode lines are electrically connected to the touch control electrodes by the lead via holes, the touch control lines are not connected between the touch control electrodes.

According to one aspect of one embodiment of the present disclosure, the pixel electrode lines are electrically connected to the touch control lines by the lead via holes.

According to one aspect of one embodiment of the present disclosure, the insulating layer is formed between the base substrate and the touch control electrode layer, the base substrate includes a plurality of pixel units, the pixel units include a plurality of thin film transistors, the bridges and source and drain electrodes of the thin film transistor are formed in a same layer.

According to one aspect of one embodiment of the present disclosure, an array substrate is provided and includes: a base substrate and a touch control electrode layer formed on the base substrate;

wherein the touch control electrode layer includes a plurality of touch control electrode insulated from each other, the touch control electrodes are electrically connected to a driving circuit by a plurality of touch control lines, the touch control lines formed in two adjacent touch control electrodes are electrically connected to each other by at least one bridge; and

wherein the touch control lines and the touch control electrodes are formed in a same layer, the bridge and the touch control electrodes are formed in different layers.

According to one aspect of one embodiment of the present disclosure, a plurality of interspaces are defined in the touch control electrodes, the touch control lines are formed in the interspaces of the touch control electrodes;

the touch control lines of each of the touch control electrodes include a first line electrically connected to the touch control electrode, the touch control lines of each of the touch control electrodes formed near the driving circuit further include a second line insulating with the touch control electrode, the second lines are connected to the first lines corresponding to the second lines by the bridges.

According to one aspect of one embodiment of the present disclosure, the touch control electrodes includes a plurality of touch control ends, the first lines of the touch control lines are electrically connected to the touch control electrodes by the touch control ends.

According to one aspect of one embodiment of the present disclosure, each of the touch control electrodes is electrically connected to the touch control lines by n touch control ends, the n is an integer and is greater than or equal to 1, each of the touch control electrodes is electrically connected to the driving circuit by n touch control lines;

wherein one touch control line is defined from one touch control end to the driving circuit.

According to one aspect of one embodiment of the present disclosure, the array substrate further includes an insulating layer, the insulating layer includes a plurality of lead via holes, the lead via holes are electrically connected to the touch control electrodes corresponding to the lead via holes.

According to one aspect of one embodiment of the present disclosure, the insulating layer is formed between the base substrate and the touch control electrode layer, the base substrate includes a plurality of pixel units, the pixel units include a plurality of thin film transistors, the bridges and gate electrodes are formed in a same layer.

According to one aspect of one embodiment of the present disclosure, the array substrate further includes a plurality of pixel electrode lines electrically connected to the touch control lines, the insulating layer is formed between the pixel electrode lines and the touch control electrode layer, the bridges are made from the pixel electrode lines.

According to one aspect of one embodiment of the present disclosure, the pixel electrode lines are electrically connected to the touch control electrodes by the lead via holes, the touch control lines are not connected between the touch control electrodes.

According to one aspect of one embodiment of the present disclosure, the pixel electrode lines are electrically connected to the touch control lines by the lead via holes.

According to one aspect of one embodiment of the present disclosure, the insulating layer is formed between the base substrate and the touch control electrode layer, the base substrate includes a plurality of pixel units, the pixel units include a plurality of thin film transistors, the bridges and source and drain electrodes of the thin film transistor are formed in a same layer.

The beneficial effect of this invention is: an array substrate is provided, touch control electrode lines are changed by public electrode lines to avoid separate preparations of touch control lines, buffer layers, and touch control via holes, to avoid two light cover processes, and to reduce costs and time for manufacturing the array substrate.

### BRIEF DESCRIPTION OF THE DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which figures those skilled in the art can derive further figures without making any inventive efforts.

FIG. 1 is a structure view of an array substrate in prior art.

FIG. 2 is a structure view of touch control lines of the array substrate in prior art.

FIG. 3 is a structure view of an array substrate of one embodiment according to the present disclosure.

FIG. 4 is a structure view of touch control lines of the array substrate of one embodiment according to the present disclosure.

FIG. 5 is a structure view of an array substrate of another embodiment according to the present disclosure.

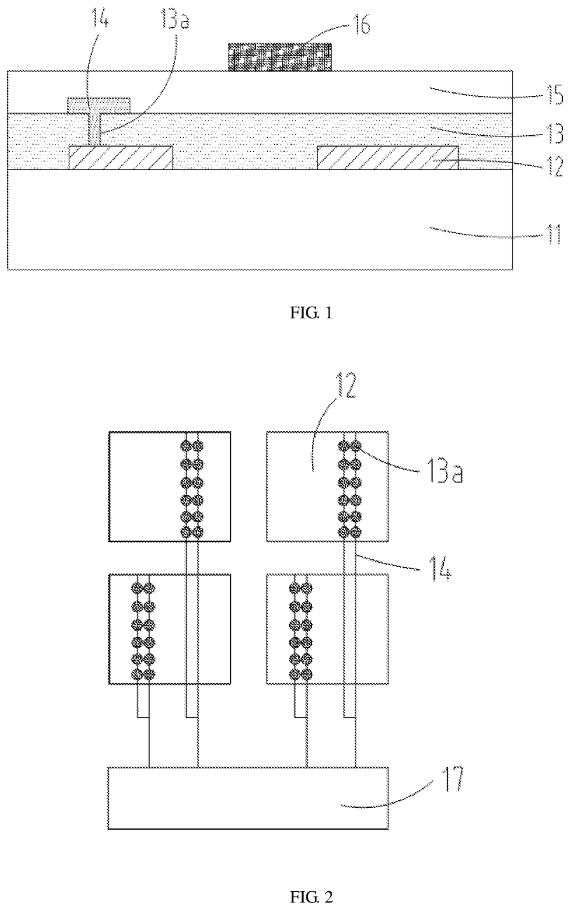

### DETAILED DESCRIPTION OF THE PREFERRED EMBODIMENTS

The description of following embodiment, with reference to the accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present disclosure. In the drawings, the components having similar structures are denoted by same numerals.

The present disclosure provides an array substrate to solve a problem of touch control lines and insulating layers increasing costs of the array substrate and making processes of manufacturing the array substrate complicated, the present disclosure can improve the defect.

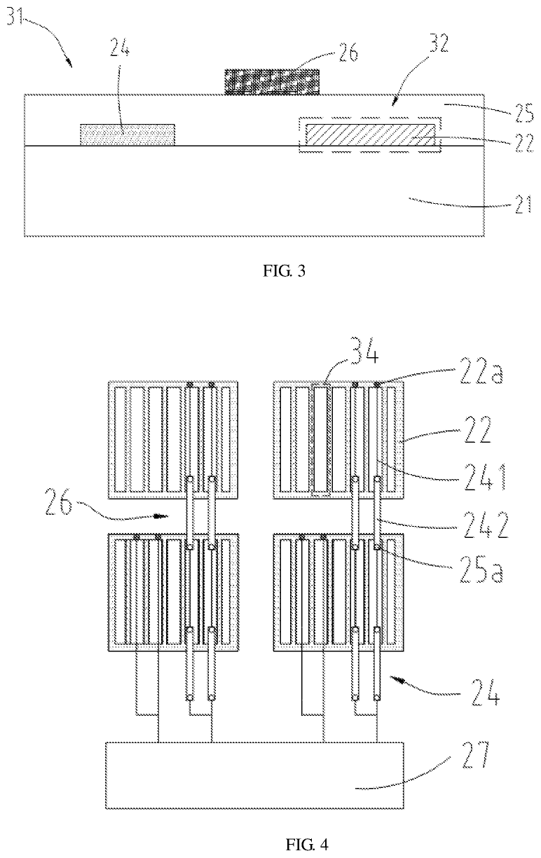

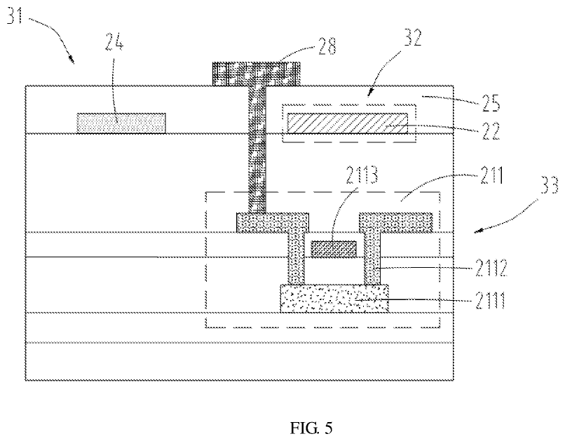

FIG. 3 is a structure view of an array substrate of one embodiment according to the present disclosure; FIG. 4 is a structure view of touch control lines of the array substrate of one embodiment according to the present disclosure; FIG. 5 is a structure view of an array substrate of another embodiment according to the present disclosure.

The present invention will be further described below in conjunction with the accompanying drawings and specific embodiments.

Referring to FIG. 3 and FIG. 4, the present disclose provides an array substrate 31 used for manufacturing an embedded touch control display panel. The array substrate 31 includes a base substrate 21 and a touch control electrode layer 32 formed on the base substrate 21.

The touch control electrode layer 32 includes a plurality of touch control electrodes 22 insulated from each other. The touch control electrodes 22 are electrically connected to a driving circuit 27 by a plurality of touch control lines 24. The touch control lines 24 formed in two adjacent touch control electrodes 22 are electrically connected to each other by at least one bridge 26.

The touch control lines 24 and the touch control electrodes 22 are formed in a same layer. The bridge 26 and the touch control electrodes 22 are formed in different layers

Further, the touch control lines 24 and the touch control electrodes 22 formed in the touch control electrode layer 32 have two advantages: 1. the touch control lines 24 and the touch control electrodes 22 are formed by one light cover process to avoid forming the touch control lines by another process; 2. the touch control lines 24 and the touch control electrodes 22 are directly electrically connected to each other without being electrically connected by other appropriative via holes to simplify process and structure of the array substrate 31.

Because each touch control line 24 is electrically connected to one touch control electrode 22 to transfer signal of the touch control electrode 22 to the driving circuit 27. In order to avoid the touch control lines 24 and the touch control electrodes 22 from being formed in a same layer to electrically connect to each other, the bridges 26 are formed to avoid shorts occurring among the touch control electrodes 22.

A plurality of interspaces 34 is defined in the touch control electrodes 22. Edges of the touch control electrodes 22 are connected. The touch control lines 24 are formed in the interspaces 34 of the touch control electrodes 22.

The touch control lines 24 of each of the touch control electrodes 22 include a first line 241 electrically connected to the touch control electrode 22. The touch control lines 24 of each of the touch control electrodes 22 formed near the driving circuit 27 further include a second line 242 insulating with the touch control electrode 22. The second lines 242 are connected to the first lines 241 corresponding to the second lines 242 by the bridges 26.

By the interspaces 34 of the touch control electrodes 22, the touch control lines 24 and the touch control electrodes 22 can be formed in a same layer. In order to make the touch control electrodes 22 and the touch control lines 24 formed in a same layer and shorts not occurred among the touch control electrodes 22, structures of the touch control electrodes 22 are not limited to the above.

Further, the touch control electrodes 22 include a plurality of touch control ends 22a. The first lines 241 of the touch control lines 24 are electrically connected to the touch control electrodes 22 by the touch control ends 22a. The touch control ends 22a are defined as contacting ends between the touch control electrodes 22 and the touch control lines 24. When the touch control electrodes 22 and the touch control lines 24 are not contacted to each other, the touch control ends 22a do not exist.

In order to insure shorts not occurred among the touch control electrodes 22, each of the touch control electrodes 22 is electrically connected to the touch control lines 24 by n touch control ends 22a, the n is an integer and is greater than or equal to 1. Each of the touch control electrodes 22 is electrically connected to the driving circuit 27 by n touch control lines 24.

One touch control line is defined from one touch control end to the driving circuit. When one touch control electrode 22 is electrically connected to the driving circuit 27 by n touch control lines, the number of the touch control ends 22a of one touch control electrode 22 is n.

The array substrate 31 includes an insulating layer 25. The insulating layer includes a plurality of lead via holes 25a. The lead via holes 25a are electrically connected to the touch control electrodes 22 corresponding to the lead via holes 25. The lead via holes 25a have a changing lines function between the touch control electrodes 22 and the bridge 26.

The insulating layer 25 can be an existing structure of the array structure. The lead via holes 25a can be formed in a patterned process of the insulating layer 25 to avoid other process, so it is easily to change lines by the lead via holes 25a.

The insulating layer 25 is formed between the base substrate 21 and the touch control electrode layer 32. The base substrate includes a plurality of pixel units 33. The pixel units 33 include a plurality of thin film transistors 211. The bridges 26 and gate electrodes 2113 are formed in a same layer. The bridges 26 and the gate electrodes 2113 are formed by one light cover process and without other process to form the bridges 26.

The array substrate 31 includes a display area and a non-display area. The pixel units 33 are defined in the display area of the array substrate 31. The pixel units 33 include data lines and scanning lines formed crosswise and thin film transistors. Each thin film transistor includes a polycrystalline silicon layer, a gate insulating layer, a source and drain electrode and a gate electrode. Because the touch control lines are needed for transferring signals, the bridges 26 are made of metal. The bridges 26 can be made of metal formed in a layer of the gate electrode 2113 and the source and drain electrode 2112 of the thin film transistor.

In one embodiment, referring to FIG. 5, the array substrate 31 further includes a plurality of pixel electrode lines 28 electrically connected to the touch control lines 24. The insulating layer 25 is formed between the pixel electrode lines 28 and the touch control electrode layer 32. The bridges 26 are made from the pixel electrode lines 28.

The pixel electrode lines 28 of the array substrate 31 are electrically connected to the source and drain electrodes to receive data signals and to control displays.

Because the touch control structure of the present disclosure is formed on the array substrate 31, the array substrate 31 is an embedded touch control display panel.

The pixel electrode lines 28 are electrically connected to the touch control electrodes 22 by the lead via holes 25a. The touch control lines 22 are not connected between the touch control electrodes 24. When the touch control signals need to be transferred, the bridges 26 can be used for transfer the touch control signals.

The pixel electrode lines 28 which are the bridges 26 are electrically connected to the touch control lines 22 by the lead via holes 25a.

The insulating layer 25 is formed between the base substrate 21 and the touch control electrode layer 32. The base substrate 21 includes a plurality of pixel units 33. The pixel units 33 include a plurality of thin film transistors 211. The bridges 26 and source and drain electrodes 2112 of the thin film transistor 211 are formed in a same layer. The bridges 26 and source and drain electrodes 2112 of the thin film transistor 211 can be formed by a same light cover process to simplify a process for manufacturing the array substrate 31.

The present disclosure also provides a display device. The array substrate 31 is used in the display device. Because a working principle of the display device is similar to a working principle of the array substrate 31, the working principle of the display device makes reference to the working principle of the array substrate.

The beneficial effect of this invention is: an array substrate is provided, touch control electrode lines are changed by public electrode lines to avoid separate preparations of touch control lines, buffer layers, and touch control via holes, to avoid two light cover processes, and to reduce costs and time for manufacturing the array substrate.

As is understood by persons skilled in the art, the foregoing preferred embodiments of the present disclosure are illustrative rather than limiting of the present disclosure. It is intended that they cover various modifications and that similar arrangements be included in the spirit and scope of the present disclosure, the scope of which should be accorded the broadest interpretation so as to encompass all such modifications and similar structures.

What is claimed is:

1. An array substrate comprising a base substrate and a touch control electrode layer and an insulating layer formed on the base substrate;
wherein the touch control electrode layer comprises a plurality of touch control electrode insulated from each other, the touch control electrodes are electrically connected to a driving circuit by a plurality of touch control lines, the touch control lines formed in two adjacent touch control electrodes are electrically connected to each other by at least one bridge;
the insulating layer comprises a plurality of lead via holes, the lead via holes are electrically connected to the touch control electrodes corresponding to the lead via holes; and
wherein the touch control lines and the touch control electrodes are formed in a same layer, the bridge and the touch control electrodes are formed in different layers.

2. The array substrate of claim 1, wherein a plurality of interspaces are defined in the touch control electrodes, the touch control lines are formed in the interspaces of the touch control electrodes;
the touch control lines of each of the touch control electrodes comprise a first line electrically connected to the touch control electrode, the touch control lines of each of the touch control electrodes formed near the driving circuit further comprise a second line insulating with the touch control electrode, the second lines are connected to the first lines corresponding to the second lines by the bridges.

3. The array substrate of claim 2, wherein the touch control electrodes comprise a plurality of touch control ends, the first lines of the touch control lines are electrically connected to the touch control electrodes by the touch control ends.

4. The array substrate of claim 3, wherein each of the touch control electrodes is electrically connected to the touch control lines by n touch control ends, wherein the n is an integer and is greater than or equal to 1, each of the touch control electrodes is electrically connected to the driving circuit by n touch control lines;
wherein one touch control line is defined from one touch control end to the driving circuit.

5. The array substrate of claim 1, wherein the insulating layer is formed between the base substrate and the touch control electrode layer, the base substrate comprises a plurality of pixel units, the pixel units comprise a plurality of thin film transistors, the bridges and gate electrodes are formed in a same layer.

6. The array substrate of claim 1, wherein the array substrate further comprises a plurality of pixel electrode lines electrically connected to the touch control lines, the insulating layer is formed between the pixel electrode lines and the touch control electrode layer, the bridges are made from the pixel electrode lines.

7. The array substrate of claim 6, wherein the pixel electrode lines are electrically connected to the touch control electrodes by the lead via holes, the touch control lines are not connected between the touch control electrodes.

8. The array substrate of claim 6, wherein the pixel electrode lines are electrically connected to the touch control lines by the lead via holes.

9. The array substrate of claim 1, wherein the insulating layer is formed between the base substrate and the touch control electrode layer, the base substrate comprises a plurality of pixel units, the pixel units comprise a plurality of thin film transistors, the bridges and source and drain electrodes of the thin film transistor are formed in a same layer.

10. An array substrate comprising a base substrate and a touch control electrode layer formed on the base substrate;
wherein the touch control electrode layer comprises a plurality of touch control electrode insulated from each other, the touch control electrodes are electrically connected to a driving circuit by a plurality of touch control lines, the touch control lines formed in two adjacent touch control electrodes are electrically connected to each other by at least one bridge; and
wherein the touch control lines and the touch control electrodes are formed in a same layer, the bridge and the touch control electrodes are formed in different layers.

11. The array substrate of claim 10, wherein a plurality of interspaces are defined in the touch control electrodes, the touch control lines are formed in the interspaces of the touch control electrodes;
the touch control lines of each of the touch control electrodes comprise a first line electrically connected to the touch control electrode, the touch control lines of each of the touch control electrodes formed near the driving circuit further comprise a second line insulating with the touch control electrode, the second lines are connected to the first lines corresponding to the second lines by the bridges.

12. The array substrate of claim 11, wherein the touch control electrodes comprises a plurality of touch control ends, the first lines of the touch control lines are electrically connected to the touch control electrodes by the touch control ends.

13. The array substrate of claim 12, wherein each of the touch control electrodes is electrically connected to the touch control lines by n touch control ends, the n is an integer and is greater than or equal to 1, each of the touch control electrodes is electrically connected to the driving circuit by n touch control lines;
wherein one touch control line is defined from one touch control end to the driving circuit.

14. The array substrate of claim 10, wherein the array substrate further comprises an insulating layer, the insulating layer comprises a plurality of lead via holes, the lead via holes are electrically connected to the touch control electrodes corresponding to the lead via holes.

15. The array substrate of claim 14, wherein the insulating layer is formed between the base substrate and the touch control electrode layer, the base substrate comprises a plurality of pixel units, the pixel units comprise a plurality of thin film transistors, the bridges and gate electrodes are formed in a same layer.

16. The array substrate of claim 14, wherein the array substrate further comprises a plurality of pixel electrode lines electrically connected to the touch control lines, the insulating layer is formed between the pixel electrode lines and the touch control electrode layer, the bridges are made from the pixel electrode lines.

17. The array substrate of claim 16, wherein the pixel electrode lines are electrically connected to the touch control electrodes by the lead via holes, the touch control lines are not connected between the touch control electrodes.

18. The array substrate of claim 16, wherein the pixel electrode lines are electrically connected to the touch control lines by the lead via holes.

19. The array substrate of claim 10, wherein the insulating layer is formed between the base substrate and the touch control electrode layer, the base substrate comprises a plurality of pixel units, the pixel units comprise a plurality of thin film transistors, the bridges and source and drain electrodes of the thin film transistor are formed in a same layer.
